(19) United States
(12) Patent Application Publication
(10) Pub. No.: US 2011/0108610 A1
(43) Pub. Date: May 12, 2011

(54) STAND-TYPE FILE FOLDER

(76) Inventor: James C. HUANG, Taichung City (TW)

(21) Appl. No.: 12/614,608

(22) Filed: Nov. 9, 2009

(51) Int. Cl. B42F 7/00

(52) U.S. Cl. 229/67.1

(57) ABSTRACT

A stand-type file folder has a file folder body having a cover backing plate and a resting plate that can swing in a zigzag state; a middle side plate, the resting plate is defined with a resting side and an assembly side; both the middle side plate and the cover backing plate are provided with a first surface; the first surface of the cover backing plate can be covered onto the first surface of the middle side plate; at least a file resting portion, placed onto either the first surface of the cover backing plate or the first surface of the middle side plate; an abutting side, formed externally onto the cover backing plate; an insert limiter, placed on the assembly side of the resting plate; the insert limiter further comprises at least two jacks and a stop limiter; the stop limiter is arranged in parallel with the abutting side.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a file folder and more particularly to an innovative one which has an abutting side that is connected with a stop limiter of an insert limiter to form a triangular stand-type file folder.

2. Description of Related Art Including Information Disclosed Under 37 CFR 1.97 and 37 CFR 1.98

Conventional file folders can only be unfolded horizontally, making it difficult to meet the user demands. For this reason, a stand-type file folder has been developed, but some shortcomings of structural configuration still exist. For example, the file folder is additionally provided with a support chip, which is inserted into the locating slot opened on two side plates of the file folder.

However, the following shortcomings are observed during actual applications: since the support chip is fabricated additionally, a certain template has to be designed for fabrication of this support chip, and fasteners must be set on the back of two side plates for locking of the support chip, leading to increase of fabrication cost against the industrial benefits.

On the other hand, the supporting end of the support chip can only be positioned by inconvenient mating of the locating slots at both side plates of the file folder.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

The enhanced efficacy of the present invention is as follows:

Based on the unique configuration of the present invention that the “stand-type file folder” mainly comprises a file folder body, an abutting side, an insert limiter and a file resting portion. Since the file folder body is provided with a cover backing plate and a resting plate that can swing in a zigzag state, the cover backing plate and the resting plate can be folded reversely to form a triangular solid frame together with the middle side plate. Then, the solid file folder can be positioned securely by the abutting side of the cover backing plate and the stop limiter of the insert limiter, enabling the file folder to be used in a standing state while meeting the user demands with ease-of-use. Meanwhile, it can reduce the structural members, cut down the cost and improve the cost-effectiveness with higher applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the file folder of the present invention in a triangular solid state.

FIG. 2 shows a perspective view of the present invention that the resting side of the resting plate is in an adhesion state.

FIG. 3 shows a schematic view of the preferred embodiment of the present invention.

FIG. 4 shows another schematic view of the preferred embodiment of the present invention.

FIG. 5 shows a schematic view of the present invention that the jack of the insert limiter can be used for inserting pens or pencils.

FIG. 6 shows a schematic view of the present invention that the cover backing plate is provided with a hollow frame.

FIG. 7 shows a schematic view of the present invention that the file folder is retracted and then positioned securely by the insert limiter.

### DETAILED DESCRIPTION OF THE INVENTION

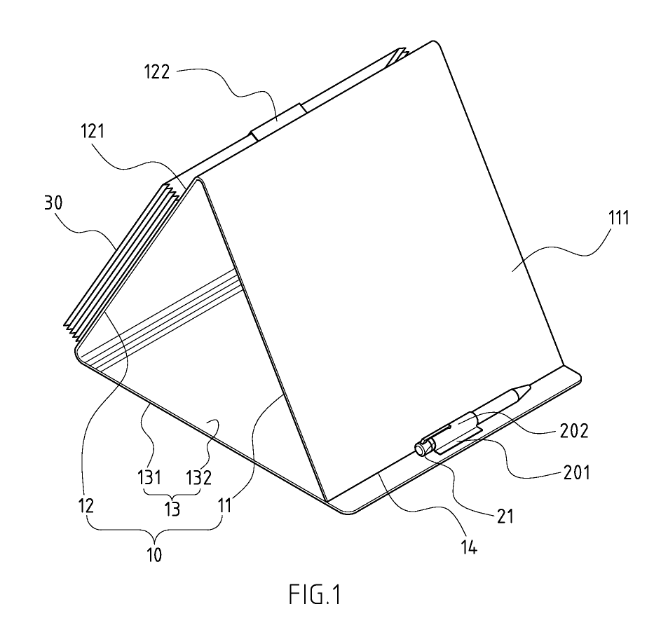

FIGS. 1-4 depict preferred embodiments of a stand-type file folder of the present invention which are provided for only explanatory objective for patent claims. Said stand-type file folder comprising:

a file folder body 10, further comprising a middle side plate 12, a cover backing plate 11 and a resting plate 13 extended to the upper and lower ends of the middle side plate 12; the cover backing plate 11 and the resting plate 13 can swing in a zigzag state; the resting plate 13 is defined with a resting side 131 and an assembly side 132; the middle side plate 12 and cover backing plate 11 are separately defined with a first surface 121, 111; the first surface 111 of the cover backing plate 11 can be covered onto the first surface 121 of the middle side plate 12; the cover backing plate 11 of the file folder body 10 and the resting plate 13 are folded reversely to form a triangular solid frame together with the middle side plate 12 (shown in FIG. 1);

a least a file resting portion 30, placed onto either the first surface 111 of the cover backing plate 11 or the first surface 121 of the middle side plate 12; the file resting portion 30 is a clip binder, a transparent file packet or an eolian file folder; the file resting portion 30 of the present invention is placed onto the first surface 121 of the middle side plate 12; the middle side plate 12 is provided with a cover plate 122 adjacent to the opening of the file resting portion 30; the cover plate 122 is folded downwards, so that the cover plate 122 can cover the opening of the file resting portion 30, thus preventing the falling of files contained in the file resting portion 30;

an abutting side 14, formed externally onto the cover backing plate 11, and locked on the stop limiter 22 of the insert limiter 20 for positioning of the solid file folder; an insert limiter 20, placed on the assembly side 132 of the resting plate 13; the insert limiter 20 further comprises at least two jacks 21 and a stop limiter 22 formed between two jacks 21 and the assembly side 132; the stop limiter 22 is arranged in parallel with the abutting side 14; the insert limiter 20 is a folded sheet that's defined into a connecting portion 201 and a flanged portion 202; the flanged portion 202 and the assembly side 132 form the corresponding jacks 21, while two flanged portions 202 and a connecting portion 201 form the grooved stop limiter 22.

With this configuration, the abutting side 14 of the cover backing plate 11 can be abutted reversely onto the stop limiter 22, so that the cover backing plate 11 can be supported flexibly to control the covering or standing of the file folder.

Of which, the jack 21 of the insert limiter 20 can be used for inserting pens or pencils for higher convenience of the file folder.

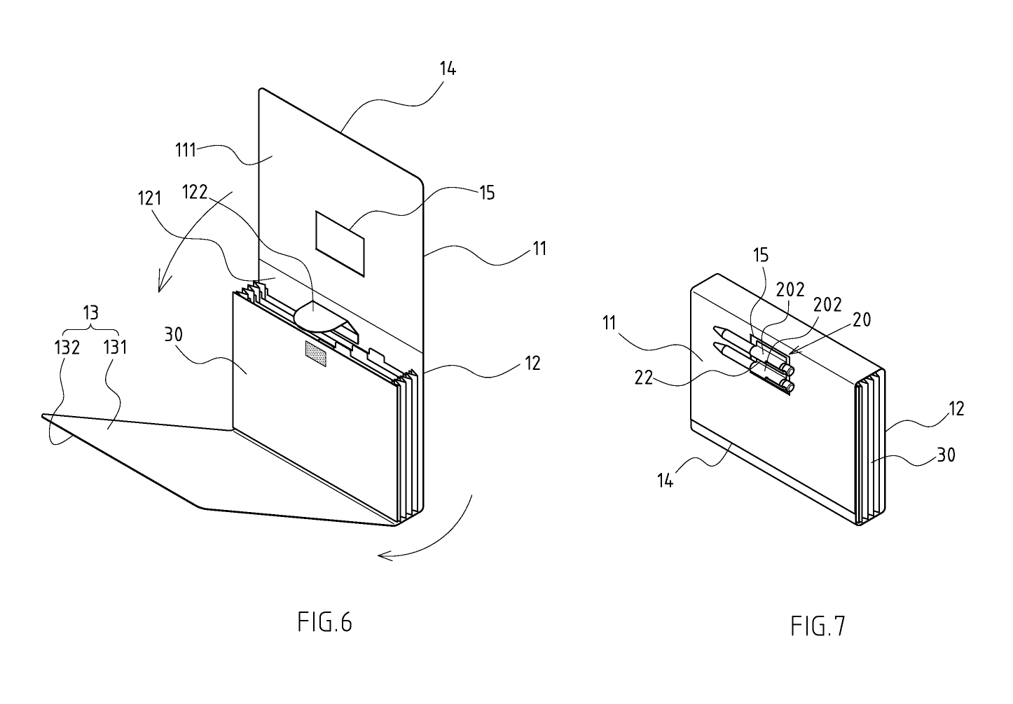

Referring to FIG. 6, the cover backing plate 11 is provided with a hollow frame 15, which is aligned with the insert limiter 20. When the cover backing plate 11 and the resting plate 13 of the file folder are folded, the insert limiter 20 can be extended across the hollow frame 15, and then the pens or pencils can be inserted into the jack 21 of the insert limiter 20 in a limited folding state, without need of other structural members (in collaboration with FIG. 7).

Additionally, the jack 21 of the insert limiter 20 can be used for inserting mobile phones or other articles so as to meet the diversified user demands including ease-of-use.

Based on above-specified structural configuration, the present invention is operated as follows:

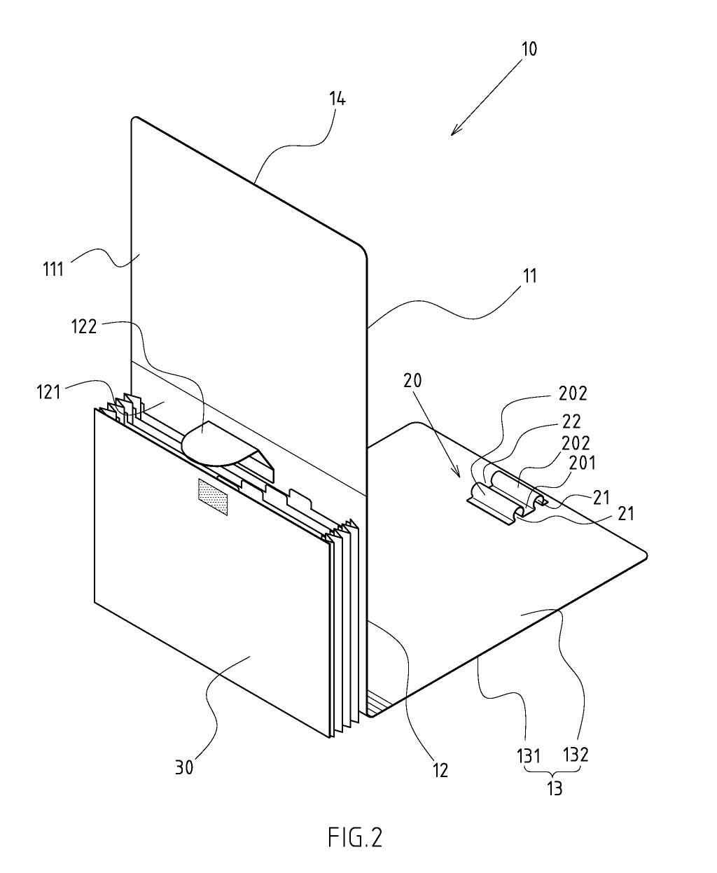

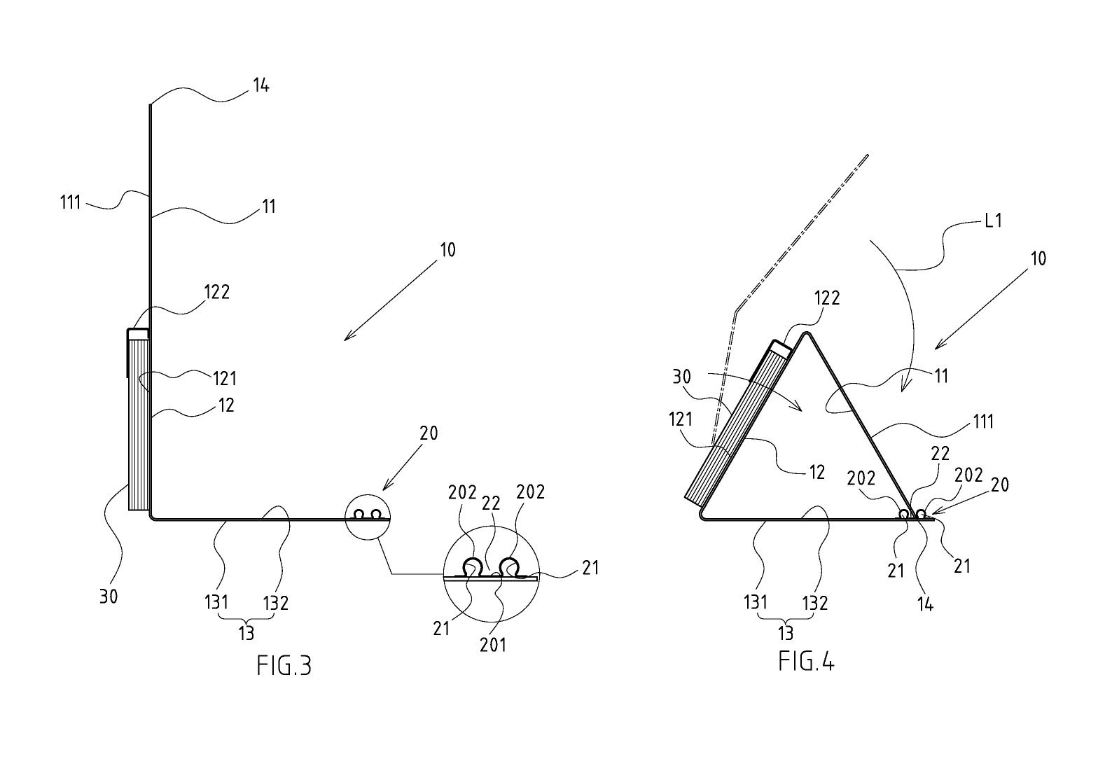

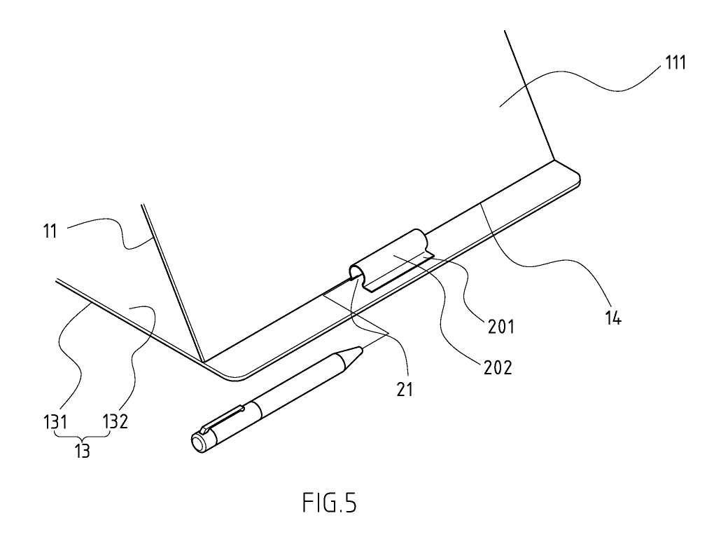

When the file folder is to be unfolded into a standing state, referring to FIGS. 2, 3, the resting plate 13 is folded reversely towards the first surface 121 of the middle side plate 12, so the resting side 131 of the resting plate 13 is adhered onto a plane, and the insert limiter 20 is arranged upwards. Next, the cover backing plate 11 is folded outwards (shown by L1 in FIG. 4), and the abutting side 14 of the cover backing plate 11 is inserted into the stop limiter 22 of the insert limiter 20 to form a triangular solid file folder. Meanwhile, the file resting portion 30 is exposed for easy retraction or presentation by the users. Referring also to FIG. 5, the jack 21 of the insert limiter 20 can be used for inserting pens or pencils, so that the solid file folder can be positioned securely.

1. A stand-type file folder, comprising:
a file folder body, further comprising a middle side plate, a cover backing plate and a resting plate extended to the upper and lower ends of the middle side plate; the cover backing plate and the resting plate can swing in a zigzag state; the resting plate is defined with a resting side and an assembly side; the middle side plate and cover backing plate are separately defined with a first surface; the first surface of the cover backing plate can be covered onto the first surface of the middle side plate; at least a file resting portion, placed onto either the first surface of the cover backing plate or the first surface of the middle side plate; an abutting side, formed externally onto the cover backing plate; an insert limiter, placed on the assembly side of the resting plate; the insert limiter further comprises at least two jacks and a stop limiter formed between two jacks and the assembly side; the stop limiter is arranged in parallel with the abutting side; with this configuration, the abutting side of the cover backing plate can be abutted reversely onto the stop limiter, so that the cover backing plate can be supported flexibly to control the covering or standing of the file folder.

2. The structure defined in claim 1, wherein the insert limiter is a folded sheet that is defined into a connecting portion and a flanged portion; the flanged portion and the assembly side form the corresponding jacks, while two flanged portions and a connecting portion form the grooved stop limiter.

3. The structure defined in claim 1, wherein the jack of the insert limiter can be used for inserting pens or pencils or other articles.

4. The structure defined in claim 1, wherein the cover backing plate is provided with a hollow frame.
